(19) United States
(12) Patent Application Publication
(10) Pub. No.: US 2008/0115806 A1
(43) Pub. Date: May 22, 2008

(54) PHOTOMASK CLEANING APPARATUS AND CLEANING METHODS USING THE SAME

(75) Inventors: Sang-Yong Yu, Yongin-si (KR); Yong-Hoon Kim, Anyang-si (KR); Se-Gun Moon, Suwon-si (KR); Jae-Hyuck Choi, Seongnam-si (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/766,699

(22) Filed: Jun. 21, 2007

(30) Foreign Application Priority Data
Nov. 16, 2006 (KR) 10-2006-0113152

(51) Int. Cl. B08B 7/04

(52) U.S. Cl. 134/18; 134/104.4; 134/56 R

(57) ABSTRACT

A photomask cleaning apparatus including a stage supporting a photomask, a cleaning fluid supplying unit configured to supply a cleaning fluid to remove contaminants from the photomask, a cleaning fluid absorbing unit configured to absorb the cleaning fluid supplied from the cleaning fluid supplying unit; and a contaminant removing structure configured to provide a path through which the cleaning fluid flows between the cleaning fluid supplying unit and the cleaning fluid absorbing unit through a surface of the photomask on the stage, and to have an opening aperture through which the cleaning fluid is exposed onto the surface of the photomask so as to remove at least some of the contaminants is provided. Methods of cleaning a photomask are also provided.

### CROSS-REFERENCE TO RELATED APPLICATION

This application claims priority to Korean Patent Application No. 10-2006-0113152, filed Nov. 16, 2006, the disclosure of which is hereby incorporated herein by reference in its entirety.

### FIELD OF THE INVENTION

The present invention relates to semiconductor device fabrication equipment and methods of cleaning components used during semiconductor device fabrication.

### BACKGROUND OF THE INVENTION

Generally, a semiconductor integrated circuit fabrication process may include several photolithography processes utilized to form circuit devices on the surface of a semiconductor substrate. In particular, to form a highly integrated circuit by a photolithography process with high reliability, a photomask is generally capable of defining a micropattern.

It appears, however, that the critical dimensions suitable for achieving a high integration density of semiconductor devices have reached the limit of resolution of an exposure apparatus. Since contaminants arising during the manufacturing process of the photomask may be linked directly with a process accident during the photolithography process, it may be desirable to remove the contaminants in advance. The contaminants can include polymer elements occurring during the photomask manufacturing process.

For example, in the photomask, a metal layer with high reflexibility, such as chrome or molybdenum, may be patterned on a transparent glass substrate. The metal layer, such as chrome or molybdenum, and a photo-resist pattern for patterning the metal layer may be formed on the transparent glass substrate. The photo-resist pattern may be patterned after the photo-resist is exposed to electron beams and developed. Thereafter, the metal layer may be patterned so as to have a predetermined image by a dry etching process using the photo-resist pattern as an etching mask. The photo-resist pattern may be removed by an ashing process in which the photo-resist combines with high temperature oxygen and may be removed by burning. Contaminants, such as polymers not completely burned during the ashing process, can occur on the entire surface of the photomask or can occur locally at any position on the photomask.

Therefore, the photomask is generally input in a relevant production process after it has a surface test using a surface metrology device, such as an electron microscope. The surface test can measure contaminants, such as polymers occurring on the photomask during the dry etching or ashing process. For example, when as a result of the surface test, it is determined that contaminants are present on the surface of the photomask, the contaminants can be removed by a photomask cleaning process.

Conventional methods of cleaning a photomask can be divided into a deep-type wet cleaning method and a spin-mode wet cleaning method. Both methods are employed to clean the entire surface of a photomask. In the deep-mode wet cleaning method, a photomask is input in a cleaning bath filled with a cleaning fluid with high etching characteristics with respect to contaminants, thereby removing the contaminants on the photomask. For example, in the deep-mode wet cleaning method, the contaminants that have a predetermined adsorbing force to be adsorbed on the surface of the photomask are removed by using a cleaning solution including chemicals, such as a sulfuric acid, with high solubility.

In the spin-mode wet cleaning method, a photomask is rotated at high speed while a liquefied cleaning fluid flows to float the contaminants of the photomask, thereby removing the contaminants by the centrifugal force. For example, in the spin-mode wet cleaning method, the photomask is rotated at a relatively high speed of about 1000 rpm or more after dropping a cleaning solution, such as deionized water, on the photomask, thereby removing the contaminants occurring on the photomask.

Therefore, in a conventional photomask, contaminants occurring on the entire surface of the photomask are cleaned by using the deep-mode wet cleaning method, which may remove the contaminants by inputting the photomask in the cleaning bath filled with the cleaning solution including particular chemicals, and the spin-mode wet cleaning method, which may remove the contaminants by dropping deionized water on the photomask and then rotating the photomask at a relatively high speed.

However, the conventional apparatus and method for cleaning a photomask can have the following problems. For example, in the apparatus and method for cleaning a photomask, when contaminants occur locally at a predetermined position on the photomask, the entire surface of the photomask is exposed in the cleaning solution by the deep-mode or spin-mode wet cleaning method. Therefore, portions of the photomask where the contaminants do not occur are likely to be contaminated inversely by contaminants contained in the cleaning solution, or the photomask pattern is likely to be damaged. Consequently, the production yield can be significantly reduced.

### SUMMARY OF THE INVENTION

Some embodiments of the present invention provide photomask cleaning apparatus including a stage supporting a photomask, a cleaning fluid supplying unit configured to supply a cleaning fluid to remove contaminants from the photomask, a cleaning fluid absorbing unit configured to absorb the cleaning fluid supplied from the cleaning fluid supplying unit; and a contaminant removing structure configured to provide a path through which the cleaning fluid flows between the cleaning fluid supplying unit and the cleaning fluid absorbing unit through a surface of the photomask on the stage, and to have an opening aperture through which the cleaning fluid is exposed onto the surface of the photomask so as to remove at least some of the contaminants. According to some embodiments, the photomask cleaning apparatus further includes a controlling unit configured to output a control signal to control a supplying pressure or an absorbing pressure of the cleaning fluid supplied from the cleaning fluid supplying unit or absorbed in the cleaning fluid absorbing unit, and configured to output a control signal to move the stage or the contaminant removing structure so that the opening aperture of the contaminant removing structure is positioned at a corresponding position of the photomask.

Some embodiments of the present invention further provide a photomask cleaning apparatus including a stage supporting a photomask, a cleaning fluid supplying unit configured to supply a cleaning fluid to remove contaminants from the photomask, a cleaning fluid absorbing unit configured to absorb the cleaning fluid supplied from the cleaning fluid supplying unit, a cleaning fluid circulating unit configured to circulate and supply the cleaning fluid, absorbed in the cleaning fluid absorbing unit, to the cleaning fluid supplying unit, a contaminant removing structure configured to provide a path through which the cleaning fluid flows between the cleaning fluid supplying unit and the cleaning fluid absorbing unit through a surface of the photomask on the stage, wherein at least some of the contaminants are removed by exposing the cleaning fluid onto the surface of the photomask through an opening aperture, and a controlling unit configured to output a control signal to control a supplying pressure or an absorbing pressure of the cleaning fluid supplied from the cleaning fluid supplying unit or absorbed in the cleaning fluid absorbing unit, and configured to output a control signal to move the stage or the contaminant removing structure so that the opening aperture of the contaminant removing structure is positioned at a corresponding position of the photomask. In some embodiments, the cleaning fluid supplying unit includes a first pump configured to supply the cleaning fluid at predetermined pressure or more, and a pressure-controlling valve configured to control the supplying pressure of the cleaning fluid supplied from the first pump. In some other embodiments, the cleaning fluid absorbing unit includes a second pump configured to pump the cleaning fluid flowing in the contaminant removing structure.

Some embodiments of the present invention provide a photomask cleaning method using a photomask cleaning apparatus, which includes a stage supporting a photomask, a cleaning fluid supplying unit configured to supply a cleaning fluid to remove contaminants from the photomask, a cleaning fluid absorbing unit configured to absorb the cleaning fluid supplied from the cleaning fluid supplying unit; and a contaminant removing structure configured to provide a path through which the cleaning fluid flows between the cleaning fluid supplying unit and the cleaning fluid absorbing unit through a surface of the photomask on the stage, and to have an opening aperture through which the cleaning fluid is exposed onto the surface of the photomask so as to remove at least some of the contaminants. The photomask cleaning method includes receiving input information of a measured position of contaminants and positioning an opening aperture and a guider of a contaminant removing structure above a photomask on which at least some of the contaminants occur, contacting the guider with the surface of the photomask or spacing the guider from the surface of the photomask at a distance corresponding to or greater than a thickness of the pattern layer, supplying a cleaning fluid; and absorbing the cleaning fluid, concurrently with or at a predetermined time difference, with supplying the cleaning fluid. In some embodiments, (a) when the opening aperture and the guider are positioned above the pattern layer of the photomask, the height of the guider is controlled so that the guider and the surface of the photomask are spaced apart from each other at the distance corresponding to or greater than the thickness of the pattern layer, and (b) when the opening aperture and the guider are positioned above a portion, other than the pattern layer, of the photomask, the height of the guider is controlled so that the guider and the surface of the photomask are at least in close proximity to each other.

Additionally, embodiments of the present invention are directed to photomask cleaning apparatus and methods that can prevent portions of a photomask where little to no contaminants are present from being contaminated inversely by contaminants contained in a cleaning solution and may further prevent a photomask pattern from being damaged when the contaminants occur locally in a predetermined position of the photomask contamination, and consequently, the production yield may increase or be maximized.

### BRIEF DESCRIPTION OF THE DRAWINGS

The above and other features and advantages of the present invention will become more apparent to those of ordinary skill in the art by describing in detail embodiments thereof with reference to the accompanying drawings in which:

FIG. 1 is a schematic diagram of a photomask cleaning apparatus according embodiments of the present invention;

FIG. 2 is a plan view of a contaminant removing structure of FIG. 1;

FIG. 3 is a perspective view of a guider of FIG. 1; and

FIG. 4 is a flow chart of a photomask cleaning method according to embodiments of the present invention.

### DETAILED DESCRIPTION

The present invention will now be described more fully hereinafter with reference to the accompanying drawings, in which various embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

Unless otherwise defined, all terms, including technical and scientific terms used in this description, have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Moreover, it will be understood that steps comprising the methods provided herein can be performed independently or at least two steps can be combined. Additionally, steps comprising the methods provided herein, when performed independently or combined, can be performed at the same temperature and/or atmospheric pressure or at different temperatures and/or atmospheric pressures without departing from the teachings of the present invention.

In the drawings, the thickness of layers and regions are exaggerated for clarity. It will also be understood that when a layer is referred to as being “on” another layer or substrate or a reactant is referred to as being introduced, exposed or feed “onto” another layer or substrate, it can be directly on the other layer or substrate, or intervening layers can also be present. However, when a layer, region or reactant is described as being “directly on” or introduced, exposed or feed “directly onto” another layer or region, no intervening layers or regions are present. Additionally, like numbers refer to like compositions or elements throughout.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “top”, “upper” and the like, may be used herein for ease of description to describe one element or feature's relationship to another element(s) or feature(s) as illustrated in the figures.

It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments of the present invention are further described herein with reference to cross-section illustrations that are schematic illustrations of idealized embodiments of the present invention. As such, variations from the shapes of the illustrations as a result, for example, of manufacturing techniques and/or tolerances, are to be expected. In particular, the regions illustrated in the figures are schematic in nature and their shapes are not intended to illustrate the precise shape of a region of a device and are not intended to limit the scope of the present invention.

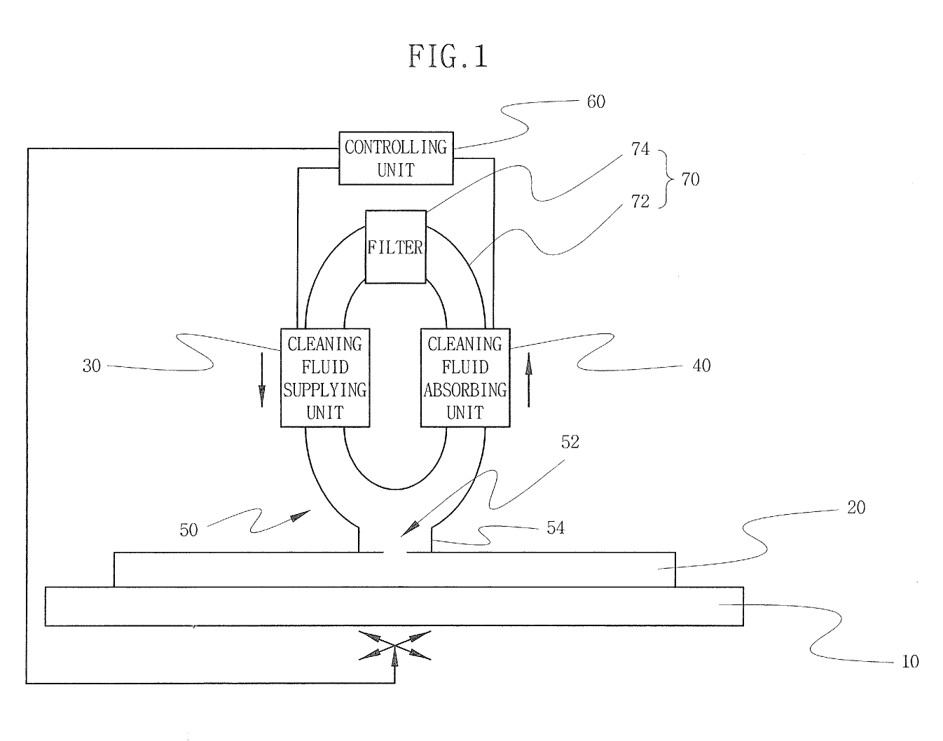

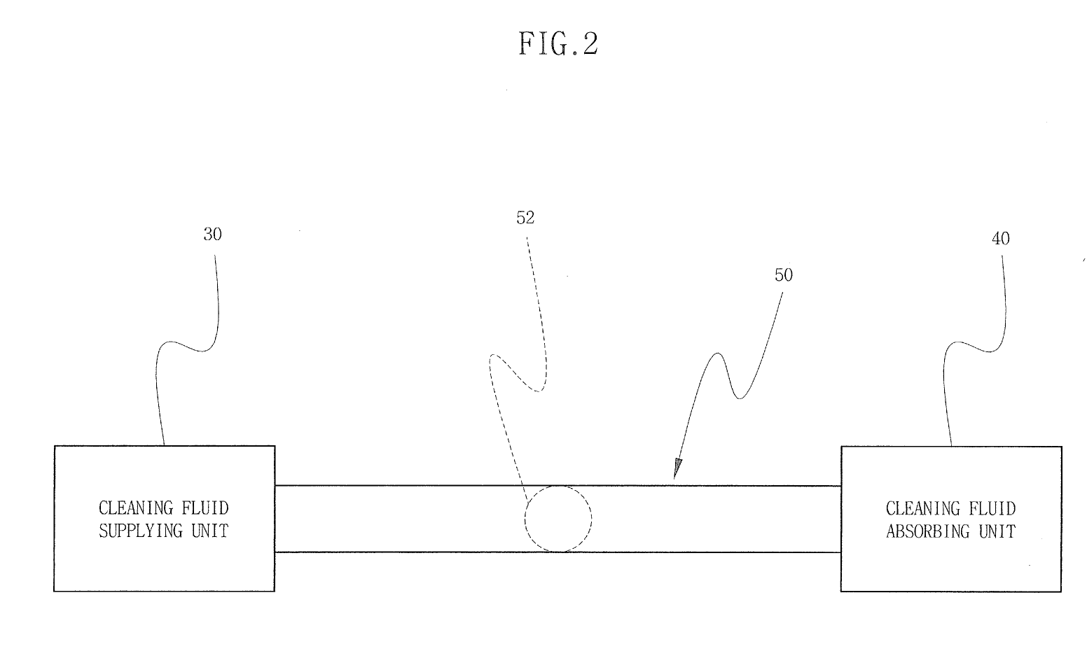

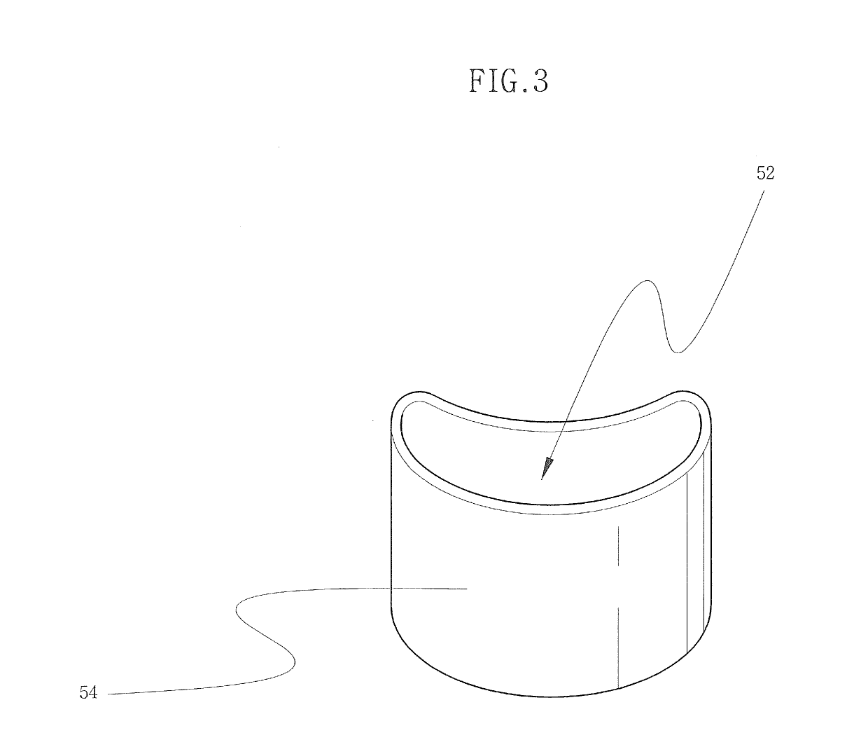

FIG. 1 is a diagram schematically illustrating a photomask cleaning apparatus according to some embodiments of the present invention, FIG. 2 is a plan view of a contaminant removing structure 50, such as a tube, of FIG. 1, and FIG. 3 is a perspective view of a guider 54 of FIG. 1.

As illustrated in FIGS. 1 through 3, the photomask cleaning apparatus of the present invention includes: a stage 10, a cleaning fluid supplying unit 30, a cleaning fluid absorbing unit 40, and a contaminant removing structure 50. The stage 10 supports a photomask 20 that can be in a horizontal state. The cleaning fluid supplying unit 30 can supply a cleaning fluid that can be at a predetermined pressure, for removing contaminants present on the photomask 20. The cleaning fluid absorbing unit 40 can absorb the cleaning fluid supplied from the cleaning fluid supplying unit 30 that can be at predetermined pressure. The contaminant removing structure 50 can provide a path through which the cleaning fluid flows, for example, from the cleaning fluid supplying unit 30 to the cleaning fluid absorbing unit 40 through the surface of the photomask on the stage 10. The contaminant removing structure 50 includes an opening aperture 52. The opening aperture 52 can be formed by opening a part of the contaminant removing structure 50 adjacent to the surface of the photomask 20. The contaminant removing structure 50 may allow the cleaning fluid to be exposed to the surface of the photomask 20 through the opening aperture 52, thereby cleaning at least some of the contaminants present on the surface.

The photomask cleaning apparatus may further comprise a controlling unit 60. The controlling unit is configured to output a control signal for controlling the supplying pressure or absorbing pressure of the cleaning fluid that can be supplied from the cleaning fluid supplying unit 30 or can be absorbed in the cleaning fluid absorbing unit 40. The controlling unit can further be configured to output a control signal for moving the stage 10 or the contaminant removing structure 50 so that the opening aperture 52 of the contaminant removing structure 50 is positioned at a corresponding position of the photomask 20.

The stage 10 can be formed to move the photomask 20 in a two-dimensional plane. For example, the stage 10 can be controlled to move in the X and Y directions of the Cartesian coordinate system defined in a plane, which is vertically in contact with the opening aperture 52. Although it is not illustrated in the drawings, the stage 10 can be moved on a plurality of linear motors (LM) guides formed in a straight line direction, in the X and Y directions by rotation of a stepping motor which can generate rotation power by a source voltage controlled by a control signal being output from the controlling unit 60.

The cleaning fluid supplying unit 30 can supply the cleaning fluid, at the predetermined pressure, so that at least some of the contaminants are removed in the contaminant removing structure 50. For example, the cleaning fluid may include a cleaning solution, such as deionized water or a sulfuric acid solution, and a cleaning gas, such as steam or nitrogen gas. Therefore, the cleaning fluid supplying unit 30 is configured to supply the cleaning solution or cleaning gas, such as deionized water, a sulfuric acid solution, steam or nitrogen gas, or to supply a mixture of at least two of these compositions into the contaminant removing structure 50. Since the deionized water, steam or nitrogen gas does not possess high reactivity with the contaminants, the contaminants may be removed in proportion to the supplying pressure or flow rate thereof supplied from the cleaning fluid supplying unit 30. A cleaning solution with strong acidic properties, such as the sulfuric acid solution, has greater chemical reactivity to contribute to the removal of at least some of the contaminants. However, when the cleaning solution, such as the sulfuric acid solution, is supplied, at excessive pressure, from the cleaning fluid supplying unit 30, a pattern layer composed of, for example, chrome or molybdenum, which is patterned in the photomask 20, is likely to be damaged. Thus, it is desirable to supply the cleaning solution, such as the sulfuric acid solution, at predetermined pressure or less, to the contaminant removing structure 50. Therefore, the cleaning fluid supplying unit 30 supplies the cleaning fluid to the contaminant removing structure 50, by differentiating the supplying pressure depending on the type of the cleaning fluid. The cleaning fluid supplying unit 30 includes a first pump (not shown) and a pressure-controlling valve (not shown). The first pump can supply the cleaning fluid at the predetermined pressure or greater. The pressure-controlling valve can control the supplying pressure of the cleaning fluid supplied from the first pump.

The cleaning fluid absorbing unit 40 can absorb the cleaning fluid that is supplied from the cleaning fluid supplying unit 30 and subsequently which flows through the contaminant removing structure 50, at a predetermined absorbing pressure. For example, it is ideal that an amount of the cleaning fluid supplied from the cleaning fluid supplying unit 30 to the contaminant removing structure 50 is the same as an amount of the cleaning fluid absorbed from the contaminant removing structure 50 into the cleaning fluid absorbing unit 40. Therefore, the cleaning fluid absorbing unit 40 absorbs the cleaning fluid at the absorbing pressure that is the same as or similar to the supplying pressure of the cleaning fluid supplied from the cleaning fluid supplying unit 30. The cleaning fluid absorbing unit 40 includes a second pump (not shown) for pumping the cleaning fluid flowing in the contaminant removing structure 50, at the predetermined absorbing pressure. The cleaning fluid is pumped out of the cleaning fluid absorbing unit 40 to be discharged outside or purified to be supplied to the cleaning fluid supplying unit 30.

Therefore, the photomask cleaning apparatus according to some embodiments of the present invention further include a cleaning fluid circulating unit 70 for purifying and/or refining the cleaning fluid absorbed in the cleaning fluid absorbing unit 40 and circulating the purified and/or refined cleaning fluid to be supplied to the cleaning fluid supplying unit 30. For example, the cleaning fluid circulating unit 70 includes a cleaning fluid circulating tube 72 and a filter 74. The cleaning fluid circulating tube 72 allows the cleaning fluid discharged from the cleaning fluid absorbing unit 40 to flow into the cleaning fluid supplying unit 30. The filter 74 can filter the cleaning fluid flowing through the cleaning fluid circulating tube 72, to remove at least some of the contaminants contained in the cleaning fluid.

The contaminant removing structure 50 allows the cleaning fluid to be exposed locally to the photomask 20 where the contaminants occur, while allowing the cleaning fluid, which is supplied from the cleaning fluid supplying unit 30, to flow to the cleaning fluid absorbing unit 40. Then, the contaminant removing structure 50 is configured so that the cleaning fluid supplied from the cleaning fluid supplying unit 30 flows onto the surface of the photomask 20 at a predetermined angle of incidence and thereafter can be absorbed in the cleaning fluid absorbing unit 40. For example, the contaminant removing structure 50 has a curved shape with the curvature at a portion adjacent to the photomask 20. The opening aperture 52 for exposing the cleaning fluid onto the surface of the photomask 20 is formed in the middle of the tip of the curvature. The opening aperture 52 formed on the tip or apex of the curvature allows the cleaning fluid to flow at a local position on the surface of the photomask 20, to remove at least some of the contaminants.

That is, the opening aperture 52 allows the cleaning fluid, which can flow downwardly in the direction perpendicular to the photomask 20, to be collided against the surface of the photomask 20. Further, the opening aperture 52 allows the cleaning fluid, which binds by colliding with the surface of the photomask 20, to be absorbed in the cleaning fluid absorbing unit 40 through the contaminant removing structure 50. Therefore, the opening aperture 52 can change the direction of the main flow of the cleaning fluid on the surface of the photomask 20, to remove more readily at least some of the contaminants present on the surface of the photomask 20. Then, as the flow direction of the cleaning fluid flowing in the contaminant removing structure 50 is changed at the curvature where the opening aperture 52 is formed, the cleaning fluid can flow with the fastest flow velocity. According to Bernoulli's Theorem, since pressure decreases if flow velocity of a fluid increases, when pressure decreases, the contaminants present on the surface of the photomask to which the cleaning fluid is exposed can be floated by the cleaning fluid and more readily removed.

The photomask cleaning apparatus according to some embodiments of the present invention include the contaminate removing structure 50 which can provide a path through which the cleaning fluid flows, from the cleaning fluid supplying unit 30 to the cleaning fluid absorbing unit 40 through the surface of the photomask 20, and which can remove at least some of the contaminants by allowing the cleaning fluid through the opening aperture 52 exposing the surface of the photomask 20 at the tip of the curvature formed by bending the portion adjacent to the surface of the photomask 20. Therefore, in the photomask cleaning apparatus according to some embodiments of the present invention, when contaminants occur locally or isolated at any position of the photomask, any other portions of the photomask where little to no contaminants occur may be prevented (or the occurrence significantly reduced) from being inversely contaminated by the cleaning fluid, and the photomask pattern can be prevented from being damaged or a least only minimal damage may result. As a result, the production yield can be increased or maximized.

For example, the opening aperture 52 can have a round shape with a radius in a range of about 2 μm to 10 μm. Further, to reduce or prevent an outward leak of the cleaning fluid exposed onto the surface of the photomask 20 through the opening aperture 52, a guider 54 can be formed to protrude in a cylindrical shape toward the photomask 20, along the circumferential surface of the opening aperture 52. For example, the guider 54 can be made of a rubber or plastic material that has desirable elastic or plastic properties, respectively. The guider 54 has a ring shape with an inner surface that extends the opening aperture 52 downward. The guider 54 can be formed so that its top end encloses the circumferential surface of the opening aperture 52 and it protrudes from the extreme outer surface of the curvature of the contaminant removing structure. The bottom end of the guider 54 that may be the segment closer to the surface of the photomask 20 may be formed to have a level plane. The bottom end of the guider 54 may be spaced apart from the surface of the photomask 20, at a predetermined height, or may be at least partially, if not fully, in contact with the surface of the photomask 20. For example, the contaminant removing structure 50 is capable of a reciprocating movement in a Z direction in the Cartesian coordinate system. Therefore, the contaminant removing structure 50 can be finely controlled in height so that the guider 54 is spaced apart from or is in contact with the surface of the photomask 20. When the cleaning fluid is supplied from the cleaning fluid supplying unit 30 after the guider 54 is positioned to be in close proximity to or in contact with the surface of the photomask 20, the cleaning fluid is collided against the inner wall of the guider 54 adjacent to the cleaning fluid absorbing unit 40 and thus swirls to remove at least some of the contaminants present on the surface of the photomask 20, and is then absorbed in the cleaning fluid absorbing unit 40 to be discharged. Then, the cleaning fluid flows to the inner wall of the guider 54 and the surface of the photomask 20, thereby floating or etching the contaminants.

The photomask cleaning apparatus according to some embodiments of the present invention include the contaminate removing structure 50 that can provide a path through which the cleaning fluid flows, from the cleaning fluid supplying unit 30 to the cleaning fluid absorbing unit 40 through the surface of the photomask 20, and which further includes the opening aperture 52, which can expose the surface of the photomask 20 at the tip of the curvature where the portion adjacent to the surface of the photomask 20 is curved or bent, and the guider 54, which at least partially protrudes toward the surface of the photomask 20 from the opening aperture 52. Therefore, in the photomask cleaning apparatus according to some embodiments of the present invention, since the contaminants can be locally removed from the photomask 20, the production yield can be increased or maximized.

A method of locally cleaning the photomask 20 by using the photomask 20 cleaning apparatus according to embodiments of the present invention will be described with reference to the figures.

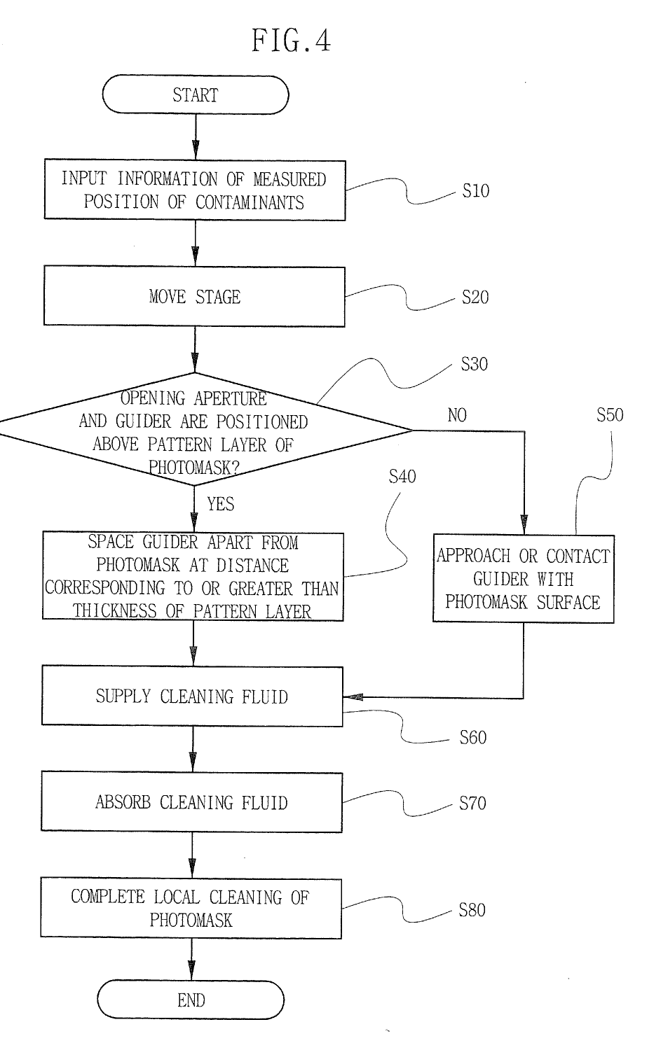

FIG. 4 is a flow chart illustrating a method, according to some embodiments of the present invention, of locally cleaning the photomask 20.

As illustrated in FIG. 4, the controlling unit 60 can receive information regarding a measured position of contaminants that can be output through a surface metrological device or a database (S10). The information regarding the measured position of contaminants can be obtained through a surface test device, such as an optical microscope or an electron microscope. The information regarding the measured position of contaminants obtained by the surface test device can be input in the controlling unit 60 or can be stored in the database to be input in the controlling unit 60. The controlling unit 60 grasps the position where the contaminants occur in the map of the photomask 20 that is pre-input. Further, the controlling unit 60 selects the type of cleaning fluid used to remove at least some of the contaminants by using an input signal being externally input and subsequently determines a cleaning time, supplying pressure and absorbing pressure.

Subsequently, the stage 10 can be moved so that the opening aperture 52 is positioned above the surface of the photomask 20 where the contaminants are present (S20). The stage 10 supporting the photomask 20 can be moved horizontally so that the opening aperture 52 formed at the tip of the curvature of the contaminant removing structure 50 is positioned at a corresponding position of the photomask 20. For example, the controlling unit 60 can output a control signal to move the stage 10 in the horizontal direction (for example, X direction or Y direction) so that the contaminants are positioned downward in a direction perpendicular to the center of the opening aperture 52.

Subsequently, it is determined whether the opening aperture 52 and the guider 54 which protrudes from the opening aperture 52, both being formed in the contaminant removing structure 50, are positioned above a pattern layer of the photomask 20 (S30). The pattern layer can be a mask layer for forming a semiconductor processing component and is adsorbed and formed, to a predetermined thickness, on the photomask 20 of, for example, a glass material. Therefore, since the pattern layer may be scratched and damaged by the guider 54, it is desirable to prevent the pattern layer from being in contact with the guider 54.

When the opening aperture 52 and the guider 54 are positioned above the pattern layer of the photomask 20, the distance between the contaminant removing structure 50 and the guider 54 is controlled so that the guider 54 and the surface of the photomask 20 are spaced apart from each other, at a distance corresponding to the thickness of the pattern layer or more (S40). For example, the controlling unit 60 can output a control signal to move the contaminant removing structure 50 perpendicularly and downward (for example, the Z direction). Then, it is desirable to control the guider 54 formed on the tip of the contaminant removing structure 50 so as not to be in contact with the pattern layer, preventing the guider 54 and the pattern layer from being damaged. Therefore, the guider 54 and the surface of the photomask 20 can be controlled to have a space being greater than the thickness of the pattern layer. Since the cleaning fluid may leak through the space between the guider 54 and the pattern layer after the cleaning fluid is supplied, it is desirable to selectively supply the cleaning fluid so as not to damage the pattern layer.

When the opening aperture 52 and the guider 54 are not positioned above the pattern layer of the photomask 20, the distance between the contaminant removing structure 50 and the guider 54 is controlled so that the guider 54 and the surface of the photomask 20 are close to each other or to be in contact with each other (S50). Since the guider 54 has predetermined elasticity, it may not damage the surface of the photomask 20 even though it makes contact with the surface of the photomask 20 including a glass material. As the guider 54 and the surface of the photomask 20 provide an airtight space, the subsequent cleaning fluid flowing through the contaminant removing structure 50 locally fills the space and flows accordingly. Therefore, the cleaning fluid may damage a part of the pattern layer but may include a cleaning solution, such as a sulfuric acid solution, having a high etching selectivity with respect to the contaminants as compared to the pattern layer.

Subsequently, when the opening aperture 52 and the guider 54 are positioned to be in close proximity to, in contact with, or spaced apart by varying distances from the surface of the photomask 20, the cleaning fluid supplying unit supplies the cleaning fluid (S60). The cleaning fluid supplying unit 30 supplies the cleaning fluid so that the contact state or distance between the contaminant removing structure 50 and the photomask 20 is consistently maintained, by progressively increasing the supplying pressure of the cleaning fluid. Because, at the beginning of supplying the cleaning fluid, the contaminant removing structure 50 and the surface of the photomask 20 may be loaded at a predetermined pressure. After air filled in the contaminant removing structure 50 is absorbed through the cleaning fluid absorbing unit 40, the cleaning fluid may be supplied from the cleaning fluid supplying unit 30. However, since the guider 54 and the photomask 20 may stick to each other by the absorbing pressure of the cleaning fluid absorbing unit 40, the pattern layer may be damaged. Therefore, before the cleaning fluid supplying unit 30 supplies the cleaning fluid, the cleaning fluid absorbing unit 40 may not absorb the air in the contaminant removing structure 50.

Subsequently, at the same time that the cleaning fluid supplying unit 30 supplies the cleaning fluid, or at a predetermined time interval, the cleaning fluid absorbing unit 40 absorbs the cleaning fluid (S70). The cleaning fluid absorbing unit 40 absorbs the cleaning fluid at the absorbing pressure that is the same as or lower than the supplying pressure of the cleaning fluid supplied from the cleaning fluid supplying unit 30, to reduce or prevent the guider 54 and the photomask 20 from being absorbed together. The cleaning fluid supplied from the cleaning fluid supplying unit 30 can flow onto the surface of the photomask 20 by the contaminant removing structure 50, the opening aperture 52 and the guider 50 of the contaminant removing structure 50, can remove the contaminants and may be absorbed in the cleaning fluid absorbing unit 40. Therefore, while the cleaning fluid flows in the contaminant removing structure 50 in one direction for a predetermined time, the contaminants exposed to the cleaning fluid through the opening aperture 52 and the guider 54 may be removed at a partial position on the surface of the photomask 20.

Finally, when the contaminants are removed, the supply of the cleaning fluid from the cleaning fluid supplying unit 30 may be stopped and the absorption of the cleaning fluid in the cleaning fluid absorbing unit 40 may be stopped. Thereafter, the guider 54 can be separated from the surface of the photomask 20, so that the partial cleaning of the photomask 20 can be completed (S80).

The methods of cleaning a photomask according to embodiments of the present invention remove at least some of the contaminants, if not substantially all, by exposing the cleaning fluid to the predetermined position of the photomask 20 where the contaminants are present. Therefore, the method of cleaning a photomask according to some embodiments of the present invention reduce or prevent the inverse contamination of the photomask 20 from the cleaning solution, which can be caused by the conventional deep-mode or spin-mode wet cleaning methods, and may reduce or prevent damage of the pattern. Consequently, the production yield can be increased or maximized.

As described above, in accordance with the present invention, the photomask cleaning apparatus includes the contaminate removing structure that can provide the path through which the cleaning fluid flows, from the cleaning fluid supplying unit to the cleaning fluid absorbing unit through the surface of the photomask, and which can remove at least some of the contaminants by flowing the cleaning fluid through the opening aperture for exposing the surface of the photomask at the tip of the curvature where the portion adjacent to the surface of the photomask is curved or bent. Therefore, when contaminants are present locally at any position on the photomask, the other portions of the photomask where little to no contaminants are present are prevented from being inversely contaminated by the cleaning fluid or there may be only a minimal effect, and the photomask pattern can be prevented from being significantly damaged. As a result, the production yield can be increased or maximized.

While the present invention has been shown and described with reference to exemplary embodiments thereof, it will be understood by those of ordinary skill in the art that the scope of the invention is not limited to the disclosed embodiments and that various changes in form and detail may be made herein without departing from the spirit and scope of the present invention, as defined by the following claims.

What is claimed is:

1. A photomask cleaning apparatus comprising:
a stage supporting a photomask,
a cleaning fluid supplying unit configured to supply a cleaning fluid to remove contaminants from the photomask;
a cleaning fluid absorbing unit configured to absorb the cleaning fluid supplied from the cleaning fluid supplying unit; and
a contaminant removing structure configured to provide a path through which the cleaning fluid flows between the cleaning fluid supplying unit and the cleaning fluid absorbing unit through a surface of the photomask on the stage, and to have an opening aperture through which the cleaning fluid is exposed onto the surface of the photomask so as to remove at least some of the contaminants.

2. The photomask cleaning apparatus according to claim 1, wherein the contaminant removing structure comprises a guider having a cylindrical shape and protruding toward the photomask and configured to decrease the leakage of the cleaning fluid exposed onto the surface of the photomask to the outside through the opening aperture.

3. The photomask cleaning apparatus according to claim 1, further comprising:
a controlling unit configured to output a control signal to control a supplying pressure or an absorbing pressure of the cleaning fluid supplied from the cleaning fluid supplying unit or absorbed in the cleaning fluid absorbing unit, and configured to output a control signal to move the stage or the contaminant removing structure so that the opening aperture of the contaminant removing structure is positioned at a corresponding position of the photomask.

4. A photomask cleaning apparatus comprising:
a stage supporting a photomask;
a cleaning fluid supplying unit configured to supply a cleaning fluid to remove contaminants from the photomask;
a cleaning fluid absorbing unit configured to absorb the cleaning fluid supplied from the cleaning fluid supplying unit;
a cleaning fluid circulating unit configured to circulate and supply the cleaning fluid, absorbed in the cleaning fluid absorbing unit, to the cleaning fluid supplying unit;
a contaminant removing structure configured to provide a path through which the cleaning fluid flows between the cleaning fluid supplying unit and the cleaning fluid absorbing unit through a surface of the photomask on the stage, wherein at least some of the contaminants are removed by exposing the cleaning fluid onto the surface of the photomask through an opening aperture; and
a controlling unit configured to output a control signal to control a supplying pressure or an absorbing pressure of the cleaning fluid supplied from the cleaning fluid supplying unit or absorbed in the cleaning fluid absorbing unit, and configured to output a control signal to move the stage or the contaminant removing structure so that the opening aperture of the contaminant removing structure is positioned at a corresponding position of the photomask.

5. The photomask cleaning apparatus according to claim 4, wherein the cleaning fluid supplying unit comprises a first pump configured to supply the cleaning fluid at predetermined pressure or more, and a pressure controlling valve configured to control the supplying pressure of the cleaning fluid supplied from the first pump.

6. The photomask cleaning apparatus according to claim 4, wherein the cleaning fluid absorbing unit comprises a second pump configured to pump the cleaning fluid flowing in the contaminant removing structure.

7. The photomask cleaning apparatus according to claim 4, wherein the stage is moved directionally along an X-axis and directionally along an Y-axis direction defined in a plane perpendicularly in contact with the opening aperture, and the contaminant removing structure is moved directionally along a Z-axis perpendicular to the plane.

8. The photomask cleaning apparatus according to claim 4, wherein the cleaning fluid circulating unit comprises (a) a cleaning fluid circulating structure configured to allow the cleaning fluid to flow to the cleaning fluid supplying unit, and (b) a filter configured to filter contaminants contained in the cleaning fluid to be removed.

9. The photomask cleaning apparatus according to claim 4, wherein the contaminant removing structure has a curvature to connect the contaminant removing structure to the photomask at a predetermined angle.

10. The photomask cleaning apparatus according to claim 9, wherein the opening aperture is formed at the center of the apex of the curvature.

11. The photomask cleaning apparatus according to claim 4, wherein the opening aperture has a radius in a range of about of 2 μm to 10 μm.

12. The photomask cleaning apparatus according to claim 4, wherein the contaminant removing structure comprises a guider having a cylindrical shape and protruding toward the photomask and configured to decrease the leakage of cleaning fluid exposed onto the surface of the photomask to the outside through the opening aperture.

13. The photomask cleaning apparatus according to claim 12, wherein the guider comprises a rubber or a plastic material with predetermined elasticity or plasticity, respectively.

14. The photomask cleaning apparatus according to claim 12, wherein the guider is formed in a ring shape with an inner surface which extends the opening aperture downward.

15. A photomask cleaning method comprising:
using a photomask cleaning apparatus having a stage supporting a photomask, a cleaning fluid supplying unit configured to supply a cleaning fluid to remove contaminants from the photomask, a cleaning fluid absorbing unit configured to absorb the cleaning fluid supplied from the cleaning fluid supplying unit; and a contaminant removing structure configured to provide a path through which the cleaning fluid flows between the cleaning fluid supplying unit and the cleaning fluid absorbing unit through a surface of the photomask on the stage, and to have an opening aperture through which the cleaning fluid is exposed onto the surface of the photomask so as to remove at least some of the contaminants;
receiving input information of a measured position of contaminants and positioning an opening aperture and a guider of a contaminant removing structure above a photomask on which at least some of the contaminants are present;
contacting the guider with the surface of the photomask or spacing the guider from the surface of the photomask at a distance about equal to or greater than a thickness of the pattern layer;
supplying a cleaning fluid; and
absorbing the cleaning fluid concurrently with or at a predetermined time difference with supplying the cleaning fluid.

16. The photomask cleaning method according to claim 15, wherein (a) when the opening aperture and the guider are positioned above the pattern layer of the photomask, a height of the guider is controlled so that the guider and the surface of the photomask are spaced apart from each other at the distance about equal to or greater than the thickness of the pattern layer, and (b) when the opening aperture and the guider are positioned above a portion, other than the pattern layer, of the photomask, the height of the guider is controlled so that the guider and the surface of the photomask are at least in close proximity to each other.

17. The photomask cleaning method according to claim 16, wherein the guider and the surface of the photomask are in contact with each other.

18. The photomask cleaning method according to claim 16, wherein, when the opening aperture and the guider are positioned above the pattern layer of the photomask, the cleaning fluid supplied through the contaminant removing structure includes deionized water or steam.

19. The photomask cleaning method according to claim 16, wherein when the opening aperture and the guider are positioned above a portion, other than the pattern layer, of the photomask, the cleaning fluid comprises a chemical solution with higher etching selectivity compared to the contaminants than that of the pattern layer.

20. The photomask cleaning method according to claim 16, wherein the cleaning fluid supplying unit supplies the cleaning fluid by progressively increasing the supplying pressure of the cleaning fluid.

21. The photomask cleaning method according to claim 16, wherein the cleaning fluid absorbing unit absorbs the cleaning fluid at an absorbing pressure that is at about the same as or lower than the supplying pressure of the cleaning fluid supplied from the cleaning fluid supplying unit, to reduce the occurrence of the guider and the photomask being adsorbed together.
